(19) United States
(12) Patent Application Publication
(10) Pub. No.: US 2011/0185772 A1
(43) Pub. Date: Aug. 4, 2011

(54) VARIABLE PRESSURE WATER DELIVERY SYSTEM

(76) Inventors: Raymond David Ruthven, Auckland (NZ); David Charles Rhodes, Auckland (NZ); Russell Joseph Jackson, Auckland (NZ)

(21) Appl. No.: 12/674,826

(22) PCT Filed: Aug. 15, 2008
(86) PCT No.: PCT/NZ2008/000216

§ 371 Date: Jun. 9, 2010

Related U.S. Application Data
(60) Provisional application No. 60/968,935, filed on Aug. 30, 2007.

(51) Int. Cl. D06F 33/00; F16K 31/02

(52) U.S. Cl. 68/12.02; 137/488

(57) ABSTRACT

A variable pressure water delivery device having an inlet valve fluidly connected to a reservoir, and connectable to a water supply, the inlet valve is at least operable between an open and closed position. The reservoir has a volume that increases elastically with increasing pressure. At least one outlet valve is fluidly connected to the reservoir and a pressure sensor is actuated by the fluid pressure in the reservoir. A controller receives an output of said pressure sensor and provides control signals to operate said inlet valve according to the output of said pressure sensor, and a desired reservoir pressure parameter.

### FIELD OF THE INVENTION

This invention relates to variable water pressure delivery systems, and in particular, but not solely, to variable pressure water delivery systems for use in whiteware appliances.

### BACKGROUND DISCUSSION

A balancing system in a washing machine contains a series of water chambers that are fed by a series of valves. The chambers are typically arranged around the circumference of a washing machine drum. The drum of the washing machine can be balanced by controlling the release of water into each of the chambers. The need for finer control of the released water increases as the drum rotation speed increases.

Early in the spin cycle large flows are needed to quickly compensate for major imbalances. At high speeds, small flows are adequate and fine control is required. In our prior art patent, U.S. Pat. No. 6,477,867, the whole contents of which is incorporated by reference, we proposed selectively supplying the chambers using a water delivery system having valves of different flow capacity.

### SUMMARY OF THE INVENTION

It is an object of the invention to provide a water delivery system that goes at least someway toward improving the abovementioned water delivery systems, or which will at least provide the whiteware industry with a useful choice.

In a first aspect the invention is said to consist in a variable pressure water delivery device, said device comprising or including:
an inlet valve fluidly connected to a reservoir, and connectable to a water supply,
   said inlet valve at least operable between an open and closed position,
   said reservoir having a volume that increases elastically with increasing pressure,
at least one outlet valve fluidly connected to said reservoir,
a pressure sensor actuated by fluid pressure in said reservoir, and
a controller receiving an output of said pressure sensor,
wherein said controller provides control signals to operate said inlet valve according to the output of said pressure sensor, and a desired reservoir pressure parameter.

Preferably said reservoir is divided into a first chamber and a second water chamber by a flexible diaphragm made of a material substantially impervious to water, inlet supplies said first chamber, said outlet is from said first chamber and said second chamber is sealed and contains a compressible fluid.

Preferably said pressure sensor is adapted to measure the pressure of said first chamber, or said second chamber, or said first chamber and said second chambers, and output a signal according to said pressure.

Preferably said inlet valve is electrically operable.

Preferably said inlet valve is connected to a water supply.

Preferably said inlet valve is operable between an open and closed position.

Preferably said inlet valve fluidly connects said water supply to said water chamber when open.

Preferably said inlet valve isolates said water supply from said water chamber when closed.

Preferably said at least one outlet valve is independently operable.

Preferably said least one outlet valve fluidly connects said water chamber to a plurality of balancing chambers when open.

Preferably said least one outlet valve isolates said second water chamber from a plurality of balancing chambers when closed.

Preferably said least one outlet valve is operable between an open that allows fluid flow, and a closed position that prevents fluid flow.

Preferably said least one outlet valve is electrically operable.

Preferably said controller is electrically connected to operate said plurality of outlet valves.

Preferably said controller is electrically connected to operate said inlet valve.

Preferably said device is adaptable for use in a whiteware appliance.

In a further aspect the invention consists in a whiteware appliance having a variable pressure water delivery device, said device comprising or including:
an inlet valve fluidly connected to a reservoir, and connectable to a water supply,
said inlet valve at least operable between an open and dosed position,
said reservoir having a volume that increases elastically with increasing pressure,
at least one outlet valve fluidly connected to said reservoir,
a pressure sensor actuated by fluid pressure in said reservoir, and
a controller receiving an output of said pressure sensor,
wherein said controller provides controls operation of said inlet valve according to the output of said pressure sensor, and a desired reservoir pressure parameter.

Preferably said controller performs the steps of:
opening said inlet valve when said reservoir pressure is below said desired range of reservoir pressure
closing said inlet valve when said reservoir pressure is above said desired range of reservoir pressure.

Preferably said controller performs the steps of:
closing said inlet valve and opening at least one said outlet valve when said reservoir pressure is above an upper pressure limit.

Preferably said reservoir is divided into a first chamber and a second water chamber by a flexible diaphragm made of a material substantially impervious to water, inlet supplies said first chamber, said outlet is from said first chamber and said second chamber is sealed and contains a compressible fluid.

Preferably said pressure sensor is adapted to measure the pressure of said first chamber, or said second chamber, or said first chamber and said second chambers, and output a signal according to said pressure.

Preferably said inlet valve is electrically operable.

Preferably said inlet valve is connected to a water supply.

Preferably said inlet valve is operable between an open and closed position.

Preferably said inlet valve fluidly connects said water supply to said water chamber when open.

Preferably said inlet valve isolates said water supply from said water chamber when closed.

Preferably said at least one outlet valve is independently operable.

Preferably said least one outlet valve fluidly connects said water chamber to a plurality of balancing chambers when open.

Preferably said least one outlet valve isolates said second water chamber from a plurality of balancing chambers when dosed.

Preferably said least one outlet valve is operable between an open that allows fluid flow, and a closed position that prevents fluid flow.

Preferably said least one outlet valve is electrically operable.

Preferably said controller is electrically connected to operate said plurality of outlet valves.

Preferably said controller is electrically connected to operate said inlet valve.

In a further aspect the invention consists in a washing appliance having a balancing system, said balancing system comprising or including:
a plurality of balancing chambers,
a reservoir where volume increases elastically with increasing pressure,
a pressure sensor actuated by fluid pressure in said reservoir,
an inlet valve fluidly connected to said reservoir, said inlet valve connectable to a water supply and operable between an open and a closed position,
a plurality of outlet valves fluidly connected between said reservoir and said plurality of balancing chambers, and
a controller receiving an output of said pressure sensor and a parameter defining a desired range of reservoir pressure, said controller performing any one of the steps of:
opening said inlet valve when said reservoir pressure is below a desired range of reservoir pressures
closing said inlet valve when said reservoir pressure is above a desired range of reservoir pressures.

Preferably said controller performs the steps of
closing said inlet valve and opening said plurality of outlet valves when said reservoir pressure is above an upper pressure limit.

Preferably said reservoir is divided into a first chamber and a second water chamber by a flexible diaphragm made of a material substantially impervious to water, inlet supplies said first chamber, said outlet is from said first chamber and said second chamber is sealed and contains a compressible fluid.

Preferably said pressure sensor is adapted to measure the pressure of said first chamber, or said second chamber, or said first chamber and said second chambers, and output a signal according to said pressure.

Preferably said inlet valve is electrically operable.

Preferably said inlet valve is connected to a water supply.

Preferably said inlet valve is operable between an open and closed position.

Preferably said inlet valve fluidly connects said water supply to said water chamber when open.

Preferably said inlet valve isolates said water supply from said water chamber when closed.

Preferably said plurality of outlet valves are each independently operable.

Preferably said plurality of outlet valves fluidly connect said water chamber to a plurality of balancing chambers when open.

Preferably said plurality of outlet valves isolate said second water chamber from a plurality of balancing chambers when closed.

Preferably said plurality of outlet valves are operable between an open that allows fluid flow, and a closed position that prevents fluid flow.

Preferably said plurality of outlet valves are electrically operable.

Preferably said controller is electrically connected to operate said plurality of outlet valves.

Preferably said controller is electrically connected to operate said inlet valve.

### BRIEF DESCRIPTION OF THE DRAWINGS

The preferred embodiment of the invention will now be described with reference to the following drawings.

FIG. 1 shows a cross-sectional view of the reservoir of the variable pressure water delivery system.

FIG. 2 shows a cross-sectional view of the reservoir of the variable pressure water delivery system having an alternative diaphragm geometry.

FIG. 3 shows a cross-section of the variable pressure water delivery system having a different arrangement of outlet valves.

FIG. 4 shows a perspective view of an exterior of the variable pressure water delivery system of FIG. 3.

FIG. 5 shows a schematic diagram of the components in the variable pressure water delivery system.

FIG. 6 shows a flow diagram for the initiation of the variable pressure water delivery system.

FIG. 7 shows a flow diagram of normal operation of the variable pressure water delivery system.

FIG. 8 shows a flow diagram of low pressure operation for the variable pressure water delivery system.

FIG. 9 show a flow diagram of high pressure operations of a variable pressure water delivery system.

FIG. 10 shows an example of the operation of the variable pressure water delivery system over time.

FIG. 11 shows a schematic view of the components in the variable pressure water delivery system having outlets connected to balancing chambers of a washing machine

### DETAILED DESCRIPTION

Briefly, and in accordance with the forgoing, a variable pressure water delivery system is provided and is particularly useful in whiteware appliances such as washing machines where delivery of a low or variable pressure fluid may be required.

The variable pressure water delivery system is connectable inline between a pressurised water source and a subsequent system or device that requires water delivered at a pressure less than the source pressure. The variable pressure water delivery system varies the source water pressure by an electromechanical feedback control. The system is able to control the water pressure between zero and the source pressure, and may do so independently of the pressure of the water supply source.

The high pressure water source is typically a mains water supply or similar supply of pressurised fluid.

The variable pressure water delivery system has a diaphragm reservoir that is between an inlet valve and one or more outlet valves. The inlet valve is connectable to a mains water supply. The reservoir includes a diaphragm that separates the reservoir into two chambers. The second chamber is sealed and contains air or other compressible fluid, the first chamber is finable with water via the inlet valve. A pressure sensor measures changes in the pressure of the first or second chamber and relays the reading to a control unit.

A control unit controls the opening and closing of the inlet valve. The controller may also control opening and closing of one or more of the outlet valves.

As water enters the first chamber, the diaphragm moves to allow the first chamber to expand by compressing the fluid within the second chamber. Pressure in the chamber rises as the fluid is compressed.

Typically the pressure sensor is monitored until a desired working pressure is reached, the inlet valve is then closed and a reservoir of water at a pressure lower than the mains pressure is provided.

The low pressure reservoir can be used for example for supplying changes in a washing machine balancing system. When the reservoir pressure drops below a desired limit, the inlet valve can be reopened until a desired reservoir pressure has been reached.

The variable pressure water delivery system may be used, for example, in a balancing system for a washing machine. The balancing system contains a series of water chambers that are fed by a series valves. The chambers are typically arranged around the circumference of a washing machine drum. The drum can be balanced by controlling the release of water into each of the chambers. The need for finer control of the released water increases as the drum rotation speed increases.

Early in the spin cycle large flows are needed to quickly compensate for major imbalances. At high speeds, small flows are adequate and fine control is required. In our prior art U.S. Pat. No. 6,477,867 we proposed selectively supplying the chambers through valves of different flow capacity. Thus coarse control does not provide the level of flexibility that would be most desirable.

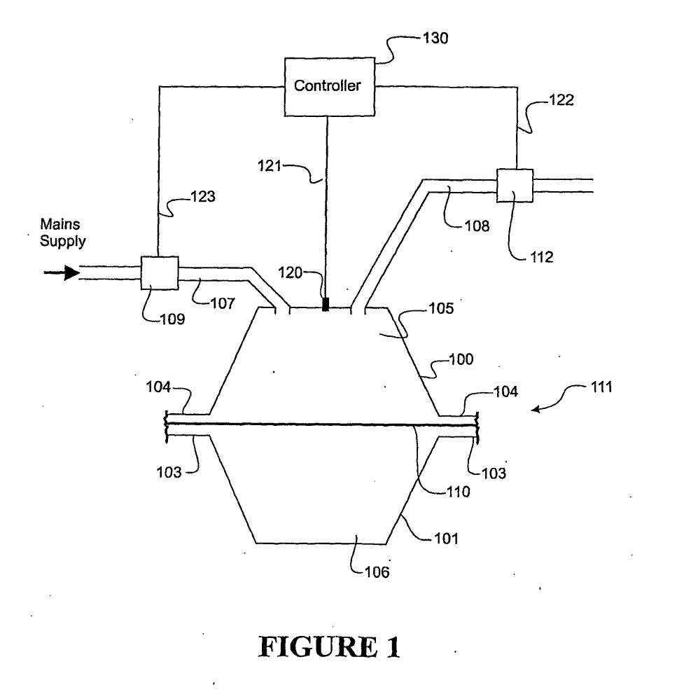

Referring to FIG. 1, a first cross sectional view of the variable pressure water delivery system of the present invention is shown. The system includes several main components: A reservoir 111, an inlet valve 109, an outlet valve 112, a pressure sensor 120 and a control unit 130.

The control unit may be a separate controller such as a microprocessor, or it may be a microprocessor that exists already in the appliance or device to which the variable pressure water delivery system is installed.

The reservoir 111 exterior is formed from an upper housing section 100 and the lower housing section 101.

A diaphragm layer 110 is located between each of the housing sections 100, 101. Preferably the diaphragm layer is sandwiched between abutting surfaces 103, 104 of the upper and lower housings 100, 101 to form a barrier layer that separates the housings. The bather may alternatively be formed by bonding the diaphragm layer 110 to the inner wall of either the upper or lower housings by a suitable bonding technique.

The diaphragm divides the reservoir 111 into an upper chamber 105 and a lower chamber 106. Preferably each of the chambers is fluidly isolated from the other by virtue of the diaphragm layer 110 forming a water impervious boundary layer.

Preferably the diaphragm 110 is made of an elastically pliant material. This means that an increase in pressure in one chamber will cause the diaphragm 110 to flex into the other chamber. Similarly, a decrease in pressure in one chamber will cause the diaphragm 110 to be drawn into that chamber. Preferably the diaphragm 110 flexes in response to changes in pressure in one chamber until the pressure in the opposite chamber has substantially equalised.

A suitable diaphragm material is one that provides the required elasticity, and is impervious to common fluids. Further advantageous diaphragm properties include a wide operating temperature range and a long lifespan. For example, butyl rubber or EPDM has been determined by the inventors to have the desired properties. However, any other material that meets such criteria may be used.

One of either the upper chamber 105 or the lower chamber 106 is a sealed chamber. The sealed chamber may contain air, or other convenient gas or compressible material. The gas may in turn be chosen for molecular size depending on the diaphragm material such that the diaphragm material does not intrinsically leak the gas.

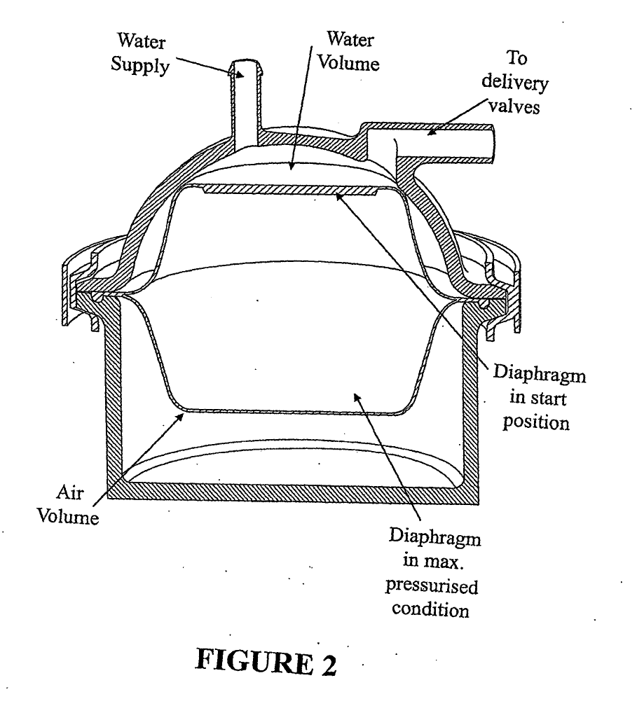

FIGS. 1 and 2 illustrate the lower chamber 106 as being the sealed gas chamber and the upper chamber 105 as a water chamber. The upper chamber 105 is intended to be filled with water, or other desired fluid, from a pressurised source. The diaphragm layer 110 flexes toward the lower chamber 106 as the upper chamber 105 is pressurised from a high pressure fluid source.

The source is typically a mains water supply or other high pressure fluid supply. Alternatively, the source may be an existing pump in an appliance. A lower pressure may additionally be desired for supplying other parts of the appliance independently from the pump operation.

The diaphragm 110 divides the reservoir into equal chambers as shown in FIG. 1. Alternatively, the diaphragm divides the reservoir 111 unequally. FIG. 2 illustrates the reservoir 111 where the diaphragm 110 consumes the majority of upper chamber 105 when in a rest position. Dividing the reservoir unequally allows the diaphragm to expand further toward, and into, the lower chamber 106. The fluid capacity of upper chamber 105 is therefore advantageously increased by allowing the diaphragm 110 a larger potential area to expand into. The fluid capacity may be optimised in this way to suit the intended application of the device and/or to minimise materials costs.

A fluid supply tube 107 is connected between the upper chamber of the reservoir 105 and the inlet valve 109. Fluid supply tube 107 is a conduit that fluidly connects the inlet valve 109 to the upper-chamber 105.

Inlet valve 109 is connectable to the source of pressurised fluid. The inlet valve 109 is ideally controllable via an electrical signal to either isolate the high pressure fluid supply from the reservoir, or fluidly connect the high pressure fluid supply to the reservoir.

The inlet valve 109 is ideally an electromechanical valve operable between an open and a closed position. The inlet valve may be a digital type valve having two positions i.e, open and closed. Alternatively, the valve may be continuously variable between open and closed positions.

An outlet tube 108 is fluidly connects the upper chamber 105 to an outlet valve 112. The outlet tube 108 provides a path for the fluid to be released from the upper chamber 105. The outlet valve 112 controls the release of fluid from the upper chamber 105.

Ideally the outlet valve 112 is an electromechanical valve that is operable either directly or indirectly by an electrical signal.

Fluid outlet tube 108 may be a single tube, or alternatively it may be a plurality of tubes. Similarly, the outlet valve 112 may be a single valve, or alternatively it may be a plurality of valves.

Any pressure inside the reservoir is maintained by the compression of the gas in the gas chamber while the inlet and outlet valves are closed.

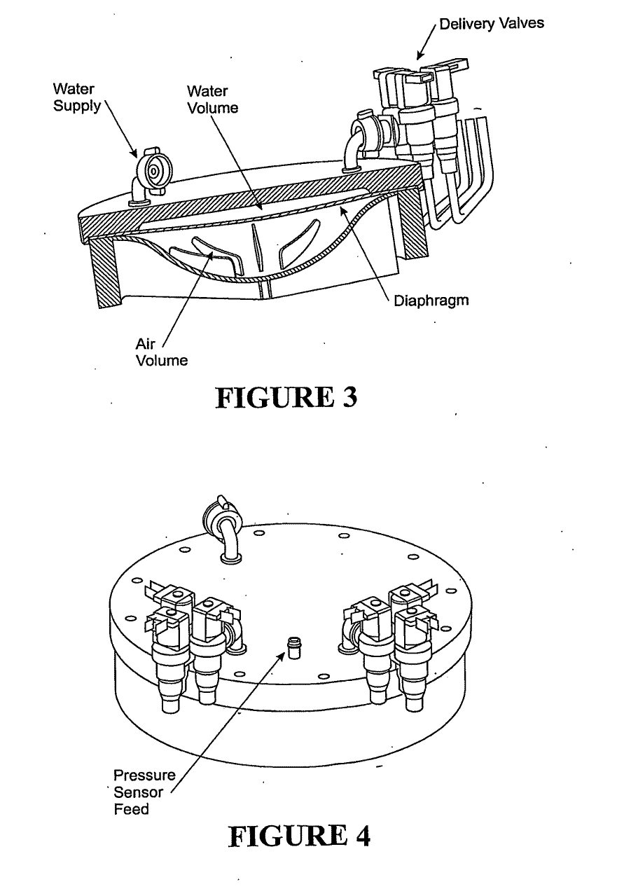

FIG. 3 illustrates a cross section of the device of the present invention where a single outlet tube connected to a plurality of outlet tubes is shown. FIG. 4 illustrates a perspective view of the device of the present invention where two groups of outlet valves are connected to the reservoir by two outlet tubes.

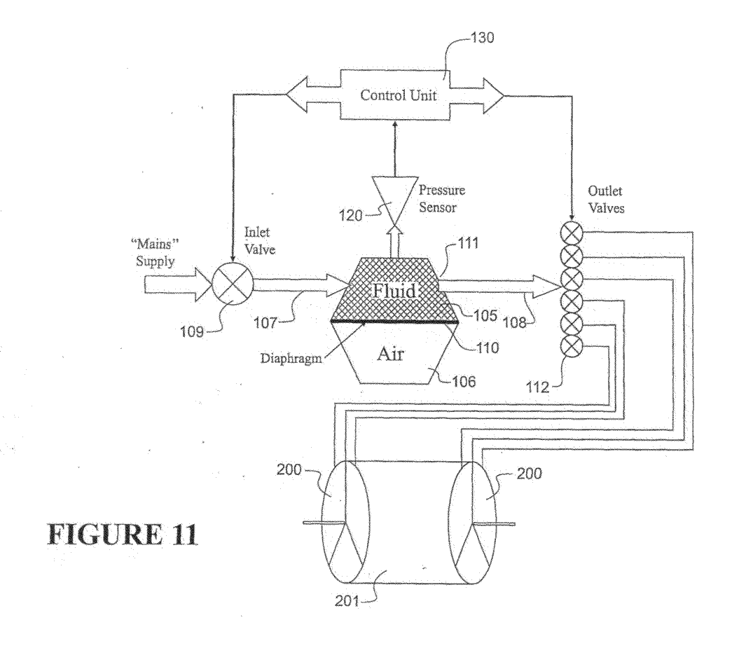

The outlet valve or valves 112 are connectable to a system or device that requires a controlled flow of fluid for example, the balancing chambers of a washing machine. FIG. 11 shows a schematic view of the components in the variable pressure water delivery system having outlets 112 connected to balancing chambers 200 of a washing machine 201. Such balancing chambers are described, for example, in our earlier U.S. Pat. No. 6,477,867.

Also shown in FIG. 1 is a pressure sensor 120. The pressure sensor 120 is connected to the upper chamber 105 to measure the internal pressure thereof. Alternatively, the pressure sensor 120 can be connected to the lower air chamber 106. The position of the pressure sensor 120 is not critical as the pressures in each chamber are allowed to equalise through the flexing of the diaphragm layer 110.

The pressure sensor may be an electrical device that sends an electrical signal to a controller unit via wire 121. Alternatively, the pressure sensor 120 may be a mechanical feed that supplies the controller unit with a mechanical send in the upper or lower chambers 105, 106 via a conduit 121, where the control unit has an inbuilt pressure sensing device.

The pressure sensor 120 may also incorporate inbuilt signal conditioning circuitry that allows it to be directly interfaced with microprocessor or analogue to digital converter type devices.

The control unit 130 is connected to the inlet valve 109 via wire 123, to the outlet valve 112 via wire 122, and to the pressure sensor 120 via wire 121.

The control unit 130 operates the opening and dosing of the inlet and outlet valves in response to the actual reservoir pressure as given by the pressure sensor 120 and a desired reservoir pressure, or range or pressures.

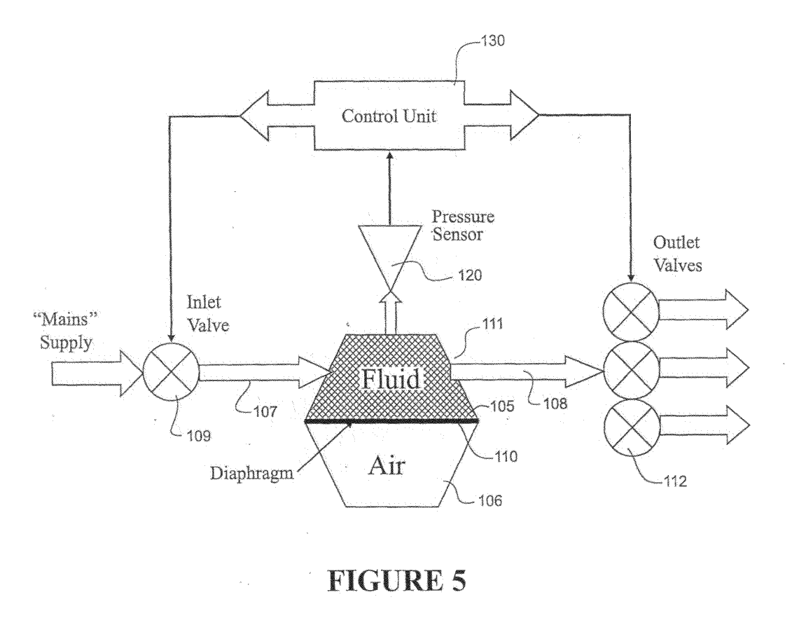

FIG. 5 is a schematic of the variable pressure water delivery system when connected to a mains supply. The control unit 130 receives an input from the pressure sensor 120 and provides a control signal to the inlet valve 109 and another control signal to the outlet valves 112.

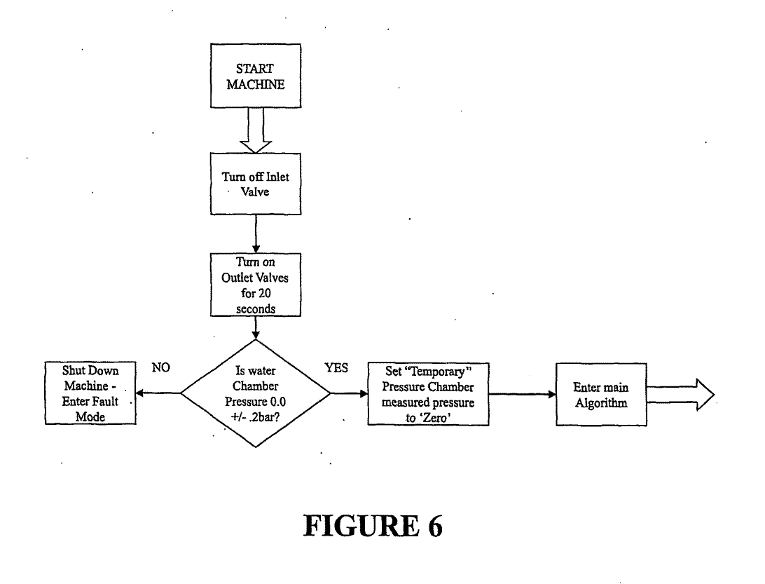

FIG. 6 shows a flow diagram of the steps the control unit uses to initialise the system. The inlet valve is first signalled to close when the system starts. This step ensures the inlet valve is closed if it is not already closed.

The outlet valves are subsequently open for a period of approximately 20 seconds. This step ensures any pressure inside the reservoir is released.

A measurement of the internal reservoir pressure is then taken by the control unit. The internal pressure is assumed to be zero, or very close thereto. The inventors have ascertained that +/−0.2 bar above atmospheric pressure provides a reliable indication that the reservoir has depressurised. A system fault is indicated if the internal pressure is outside this range. For example, the fault may be caused by a leaking inlet valve.

If the internal pressure is within the specified limit, the control unit sets the measured reservoir pressure parameter to zero. The main operation algorithm is then initialised.

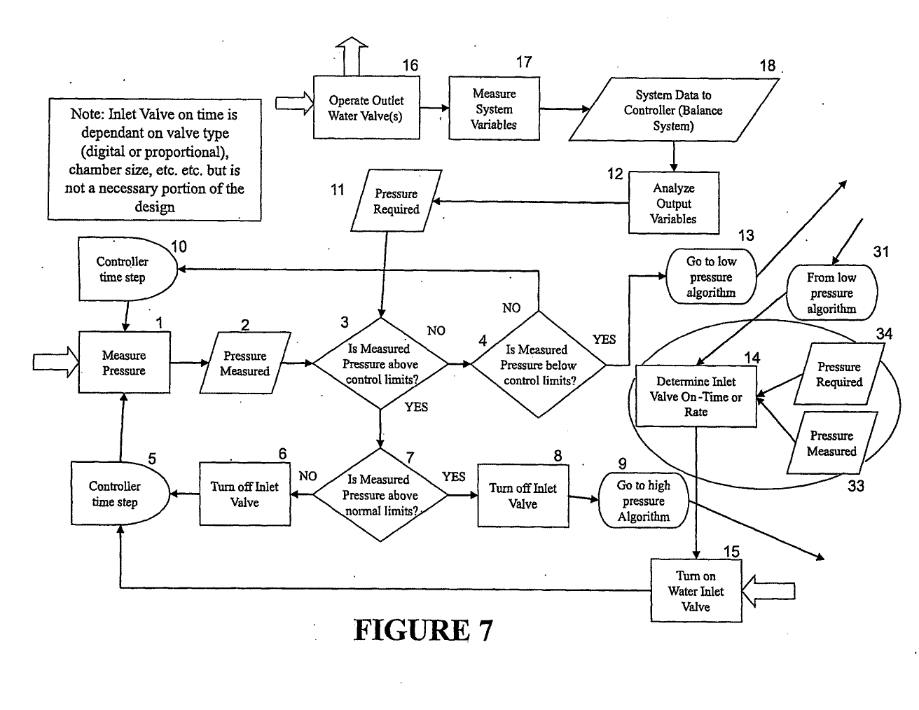

FIG. 7 illustrates a flow diagram of the main control algorithm used to control operation of the variable pressure water delivery system. The main algorithm will be described when the system is connected to a typical balancing system of a washing machine.

Ideally the washing machine balancing system is connected to a fluid source that facilitates fine control of the fluid released into a balancing chamber. The variable pressure water delivery system of the present invention provides the fluid source that is adaptable to the changing fluid pressure requirements of the balancing system.

The pressure requirements are preferably defined during initialisation of the balancing system. For example, during a spin cycle, the outlet valves are operated at step 16 and the subsequent effect of an out-of-balance condition is measured at step 17.

A balancing system controller that already exists in the washing appliance determines at step 18 the quantity of fluid to be supplied to each balancing chamber. The quantity of fluid will change depending on the speed of the spin cycle, and the magnitude of out-of-balance forces. Therefore, a low water pressure is required to supply small amounts of water to provide fine control of the balancing system at high rotation speeds. Similarly, a high water pressure is required to supply large amounts of water to control large forces at low speeds.

Those skilled in the art of washing machine balancing systems will appreciate the required water pressure will change depending on the out-of-balance forces, and that a single water pressure may not allow a complete control across a range of out-of-balance forces for a given valve speed.

The balancing system controller determines the most useful pressure range at step 12 and provides this information at step 11 to the variable pressure water delivery system control unit 130.

The main operation algorithm of the variable pressure water delivery system initialises at the first step 1 where the internal reservoir pressure is measured at step 2 and stored as the measured pressure variable at block 33.

The desired reservoir pressure range at block 34 and the measured reservoir pressure at block 33 can be used to predetermine the time period the inlet valve is opened at step 14. Alternatively the inlet valve can be opened to pressurise the reservoir until the measured pressure is rises into the desired pressure range.

The desired pressure range for ideal operation of the balancing system has an upper and lower pressure limit. The balancing system will operate correctly for a given water requirement when the reservoir pressure is between the upper and lower limits.

Fine control of the fluid released into the balancing chambers is lost when the reservoir pressure is above the upper pressure limit. In addition, the reservoir may be damaged if the reservoir pressure becomes too high.

Similarly, the balancing system may not receive enough fluid if the reservoir pressure drops below the lower limit. A low pressure algorithm is initialised if the measured reservoir pressure is below the lower control limit.

In the main operation algorithm, the measured reservoir pressure is compared at step 3 to the upper pressure limit.

If the measured pressure is above the upper pressure limit, the measured pressure is then compared at step 7 to a maximum pressure limit that is predetermined as the absolute pressure limit for the reservoir.

The inlet valve is signalled at step 8 to turn off and a high pressure algorithm is initialised at step 9 if the measured pressure is above the maximum pressure limit.

The inlet valve is signalled at step 6 to turn off and a controller time step is performed if the measured pressure is above the upper pressure limit and below the maximum pressure limit. The pressure measurements process at step 1 is then repeated.

If the measured pressure is below the upper pressure limit, the measured pressure is compared at step 4 to the lower pressure limit.

A controller time step is preformed at step 10 and the measurement process repeated if the measured pressure is above the lower pressure limit, and below the lower pressure limit.

A low pressure algorithm is initialised at step 13 if the measured reservoir pressure is below the lower pressure limit.

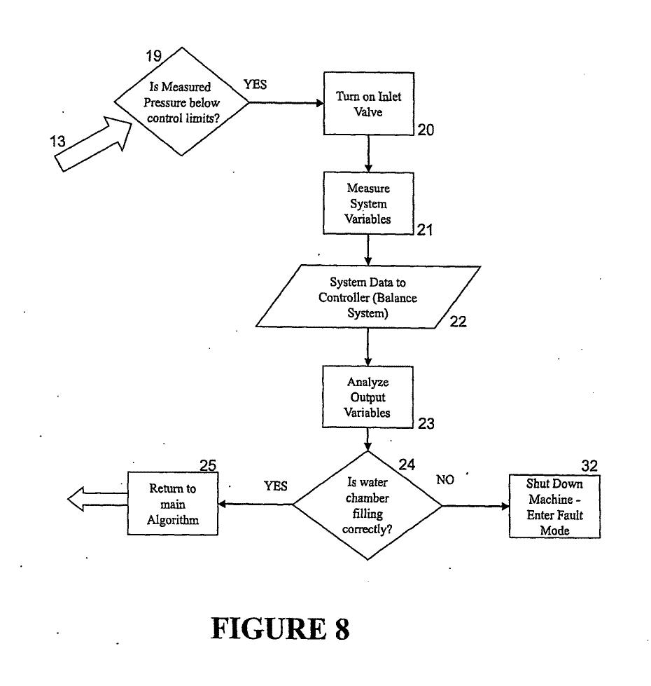

FIG. 8 illustrates a flow diagram of the control steps taken during the low pressure algorithm. The inlet valve is signalled to turn on at step 20 when the reservoir pressure has been determined to be below the lower control limit at step 19. The reservoir pressure is monitored at step 21 and compared at step 22 to the desired reservoir pressure range.

The reservoir pressure is subsequently monitored at step 23 by the control unit to ensure the pressure is rising as the reservoir fills. The low pressure algorithm is exited and the mains operation algorithm reinitialised if the reservoir is determined to be filling correctly at steps 24, 25. A system fault is indicated at step 32 if the reservoir is determined to not be filling correctly.

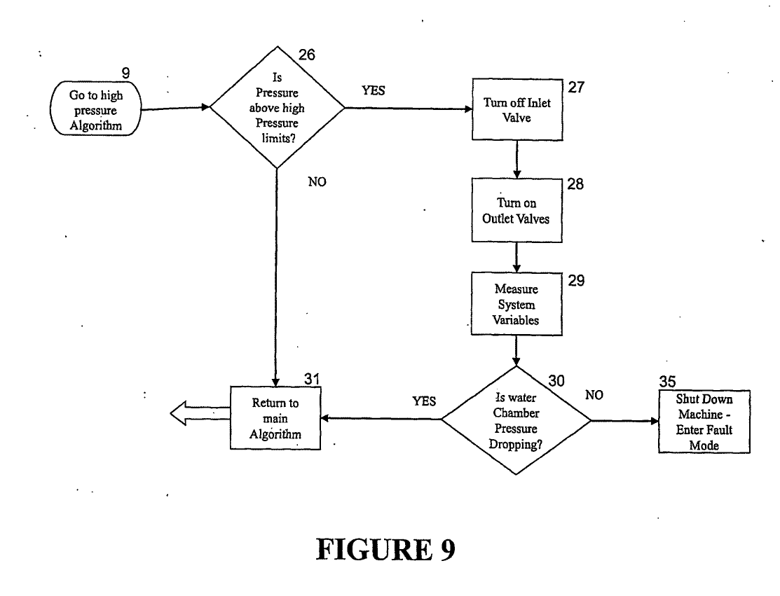

FIG. 9 illustrates a flow diagram of the high pressure control algorithm. The reservoir pressure is measured at step 26 to re-establish the pressure is above the working pressure range of the system. The main operation algorithm is re-entered at step 31 if the reservoir pressure has dropped below the upper pressure limit. This may occur when the outlet valves are open and water is being released from the reservoir thus causing a reduction in pressure.

The inlet valve is signalled to close at step 27 if the reservoir pressure is above the upper pressure limit. The outlet valve or valves are then signalled to open at step 28. Opening the outlet valves releases excess pressure from the reservoir. The reservoir pressure is monitored at step 30 to determine whether it is dropping. A system fault is indicated at step 38 if the reservoir pressure is not dropping as expected. This may indicate a leaking inlet valve, or malfunctioning outlet valves.

The control unit reinitialises the normal operation algorithm if the reservoir pressure drops back into normal working limits.

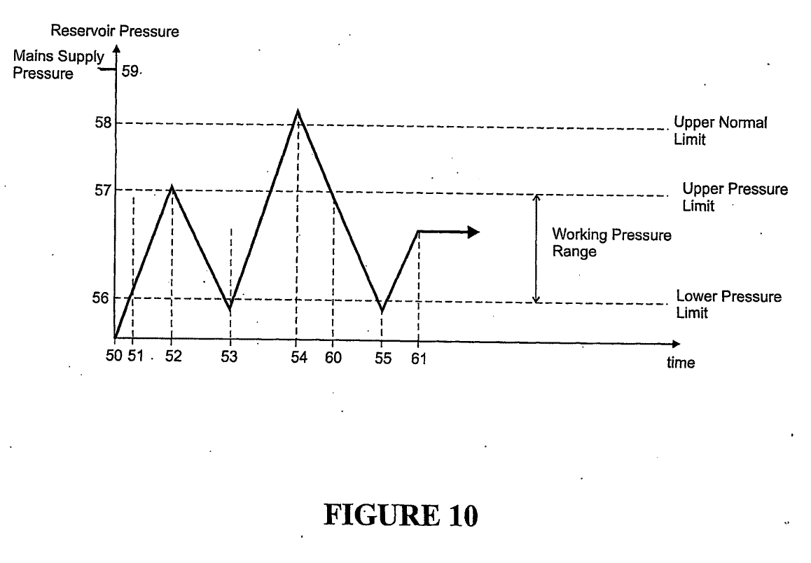

FIG. 10 illustrates an example operation scenario. The control unit initialises the system at the first time point 50. The reservoir pressure is at or substantially close to zero while the mains water supply pressure 59 is above the desired range of working pressure.

The inlet valve 109 is opened to pressurise and fill the reservoir with water by expansion of the diaphragm layer 110. The outlet valve or valves 112 can be opened when the reservoir pressure reaches the lower working pressure limit 56 at time point 51.

The control unit signals the inlet valve 109 to close when the reservoir pressure is determined as being above the upper pressure limit 57 at time point 52.

The outlet valve or valves maintain operation and the reservoir pressure drops accordingly. The inlet valve is signalled to reopen at time point 53 when the control unit determines the reservoir pressure has dropped below the lower control limit 56.

The reservoir pressure is measured as being above the upper working pressure limit 57 and the upper normal limit 58 at time point 54. This may occur due to a leaking inlet valve, the use of a small reservoir or a high mains pressure source being used in conjunction with a relatively small reservoir. The control unit initialises the high pressure algorithm to reduce the reservoir pressure. This means the inlet valve is signalled to close and the outlet valve or valves are signalled to open.

The outlet valves may resume normal operation at time point 60 when the reservoir pressure drops into the working range at time point 60. The reservoir pressure will continue to drop until it reaches the lower pressure limit 56 at time point 55. The control unit then opens the inlet valve to refill the reservoir.

The outlet valve or valves are not utilised after time point 61 and the reservoir maintains water pressure until they are again required.

Therefore a variable pressure water delivery system is shown to provide the advantage of deriving a low range of pressures from a high pressure source.

Further provided is a variable pressure water delivery system that provides the advantage of delivering water at a pressure anywhere between zero and the mains supply pressure.

Further provided is a variable pressure water delivery system that requires a minimum of moving parts, thereby improving regulator life.

Further provided is a variable pressure water delivery system that may provide the abovementioned advantages and is built from individual components that have proven reliability.

Further provided is a variable pressure water delivery system that may be used with any other type of appliance that utilises a pressurised fluid supply.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. A variable pressure water delivery device comprising or including:
an inlet valve fluidly connected to a reservoir, and connectable to a water supply,
said inlet valve at least operable between an open and closed position,
said reservoir having a volume that increases elastically with increasing pressure,
at least one outlet valve fluidly connected to said reservoir,
a pressure sensor actuated by fluid pressure in said reservoir, and
a controller receiving an output of said pressure sensor,
wherein said controller provides control signals to operate said inlet valve according to the output of said pressure sensor, and a desired reservoir pressure parameter.

2. A variable pressure water delivery device as claimed in claim 1, wherein said reservoir is divided into a first chamber and a second water chamber by a flexible diaphragm made of a material substantially impervious to water, inlet supplies said first chamber, said outlet is from said first chamber and said second chamber is sealed and contains a compressible fluid.

3. A variable pressure water delivery device as claimed in claim 1 or claim 2, wherein said pressure sensor is adapted to measure the pressure of said first chamber, or said second chamber, or said first chamber and said second chambers, and output a signal according to said pressure.

4. A variable pressure water delivery device as claimed in any one of claims 1 to 3, wherein said inlet valve is electrically operable.

5. A variable pressure water delivery device as claimed in any one of claims 1 to 4, wherein said inlet valve is connected to a water supply.

6. A variable pressure water delivery device as claimed in any one of claims 1 to 5, wherein said inlet valve is operable between an open and closed position.

7. A variable pressure water delivery device as claimed in any one of claims 1 to 6, wherein said inlet valve fluidly connects said water supply to said water chamber when open.

8. A variable pressure water delivery device as claimed in any one of claims 1 to 7, wherein said inlet valve isolates said water supply from said water chamber when dosed.

9. A variable pressure water delivery device as claimed in any one of claims 1 to 8, wherein said at least one outlet valve is independently operable.

10. A variable pressure water delivery device as claimed in any one of claims 1 to 9, wherein said least one outlet valve fluidly connects said water chamber to a plurality of balancing chambers when open.

11. A variable pressure water delivery device as claimed in any one of claims 1 to 10, wherein said least one outlet valve isolates said second water chamber from a plurality of balancing chambers when closed.

12. A variable pressure water delivery device as claimed in any one of claims 1 to 11, wherein said least one outlet valve is operable between an open that allows fluid flow, and a closed position that prevents fluid flow.

13. A variable pressure water delivery device as claimed in any one of claims 1 to 12, wherein said least one outlet valve is electrically operable.

14. A variable pressure water delivery device as claimed in any one of claims 1 to 13, wherein said controller is electrically connected to operate said plurality of outlet valves.

15. A variable pressure water delivery device as claimed in any one of claims 1 to 14, wherein said controller is electrically connected to operate said inlet valve.

16. A variable pressure water delivery device as claimed in any one of claims 1 to 15 wherein said device is adaptable for use in a whiteware appliance.

17. A whiteware appliance including a variable pressure water delivery device comprising or including:
an inlet valve fluidly connected to a reservoir, and connectable to a water supply,
said inlet valve at least operable between an open and closed position,
said reservoir having a volume that increases elastically with increasing pressure,
at least one outlet valve fluidly connected to said reservoir,
a pressure sensor actuated by fluid pressure in said reservoir, and
a controller receiving an output of said pressure sensor,
wherein said controller provides controls operation of said inlet valve according to the output of said pressure sensor, and a desired reservoir pressure parameter.

18. A whiteware appliance including a variable pressure water delivery device as claimed in claim 17, wherein said controller performs the steps of
opening said inlet valve when said reservoir pressure is below said desired range of reservoir pressure
closing said inlet valve when said reservoir pressure is above said desired range of reservoir pressure.

19. A whiteware appliance including a variable pressure water delivery device as claimed in claim 17 or 18, wherein said controller performs the steps of:
closing said inlet valve and opening at least one said outlet valve when said reservoir pressure is above an upper pressure limit.

20. A whiteware appliance including a variable pressure water delivery device as claimed in any one of claims 17 to 19, wherein said reservoir is divided into a first chamber and a second water chamber by a flexible diaphragm made of a material substantially impervious to water, inlet supplies said first chamber, said outlet is from said first chamber and said second chamber is sealed and contains a compressible fluid.

21. A whiteware appliance including a variable pressure water delivery device as claimed in any one of claims 17 to 20, wherein said pressure sensor is adapted to measure the pressure of said first chamber, or said second chamber, or said first chamber and said second chambers, and output a signal according to said pressure.

22. A whiteware appliance including a variable pressure water delivery device as claimed in any one of claims 17 to 21, wherein said inlet valve is electrically operable.

23. A whiteware appliance including a variable pressure water delivery device as claimed in any one of claims 17 to 22, wherein said inlet valve is connected to a water supply.

24. A whiteware appliance including a variable pressure water delivery device as claimed in any one of claims 17 to 23, wherein said inlet valve is operable between an open and dosed position.

25. A whiteware appliance including a variable pressure water delivery device as claimed in any one of claims 17 to 24, wherein said inlet valve fluidly connects said water supply to said water chamber when open.

26. A whiteware appliance including a variable pressure water delivery device as claimed in any one of claims 17 to 25, wherein said inlet valve isolates said water supply from said water chamber when closed.

27. A whiteware appliance including a variable pressure water delivery device as claimed in any one of claims 17 to 26, wherein said at least one outlet valve is independently operable.

28. A whiteware appliance including a variable pressure water delivery device as claimed in any one of claims 17 to 27, wherein said least one outlet valve fluidly connects said water chamber to a plurality of balancing chambers when open.

29. A whiteware appliance including a variable pressure water delivery device as claimed in any one of claims 17 to 28, wherein said least one outlet valve isolates said second water chamber from a plurality of balancing chambers when closed.

30. A whiteware appliance including a variable pressure water delivery device as claimed in any one of claims 17 to 29, wherein said least one outlet valve is operable between an open that allows fluid flow, and a closed position that prevents fluid flow.

31. A whiteware appliance including a variable pressure water delivery device as claimed in any one of claims 17 to 30, wherein said least one outlet valve is electrically operable.

32. A whiteware appliance including a variable pressure water delivery device as claimed in any one of claims 17 to 31, wherein said controller is electrically connected to operate said plurality of outlet valves.

33. A whiteware appliance including a variable pressure water delivery device as claimed in any one of claims 17 to 32, wherein said controller is electrically connected to operate said inlet valve.

34. A washing appliance having a balancing system, said balancing system comprising or including:
a plurality of balancing chambers,
a reservoir where volume increases elastically with increasing pressure,
a pressure sensor actuated by fluid pressure in said reservoir,
an inlet valve fluidly connected to said reservoir, said inlet valve connectable to a water supply and operable between an open and a closed position,
a plurality of outlet valves fluidly connected between said reservoir and said plurality of balancing chambers, and
a controller receiving an output of said pressure sensor and a parameter defining a desired range of reservoir pressure, said controller performing any one of the steps of:
opening said inlet valve when said reservoir pressure is below a desired range of reservoir pressures
closing said inlet valve when said reservoir pressure is above a desired range of reservoir pressures.

35. A washing appliance as claimed in claim 34, wherein said controller performs the steps of:
closing said inlet valve and opening said plurality of outlet valves when said reservoir pressure is above an upper pressure limit.

36. A washing appliance as claimed in claim 34 or 35, wherein said reservoir is divided into a first chamber and a second water chamber by a flexible diaphragm made of a material substantially impervious to water, inlet supplies said first chamber, said outlet is from said first chamber and said second chamber is sealed and contains a compressible fluid.

37. A washing appliance as claimed in any one of claims 34 to 36, wherein said pressure sensor is adapted to measure the pressure of said first chamber, or said second chamber, or said first chamber and said second chambers, and output a signal according to said pressure.

38. A washing appliance as claimed in any one of claims 34 to 37, wherein said inlet valve is electrically operable.

39. A washing appliance as claimed in any one of claims 34 to 38, wherein said inlet valve is connected to a water supply.

40. A washing appliance as claimed in any one of claims 34 to 39, wherein said inlet valve is operable between an open and closed position.

41. A washing appliance as claimed in any one of claims 34 to 40, wherein said inlet valve fluidly connects said water supply to said water chamber when open.

42. A washing appliance as claimed in any one of claims 34 to 41, wherein said inlet valve isolates said water supply from said water chamber when closed.

43. A washing appliance as claimed in any one of claims 34 to 42, wherein said plurality of outlet valves are each independently operable.

44. A washing appliance as claimed in any one of claims 34 to 43, wherein said plurality of outlet valves fluidly connect said water chamber to a plurality of balancing chambers when open.

45. A washing appliance as claimed in any one of claims 34 to 44, wherein said plurality of outlet valves isolate said second water chamber from a plurality of balancing chambers when closed.

46. A washing appliance as claimed in any one of claims 34 to 45, wherein said plurality of outlet valves are operable between an open that allows fluid flow, and a closed position that prevents fluid flow.

47. A washing appliance as claimed in any one of claims 34 to 46, wherein said plurality of outlet valves are electrically operable.

48. A washing appliance as claimed in any one of claims 34 to 47, wherein said controller is electrically connected to operate said plurality of outlet valves.

49. A washing appliance as claimed in any one of claims 34 to 48, wherein said controller is electrically connected to operate said inlet valve.
